(19) United States
(12) Patent Application Publication
(10) Pub. No.: US 2011/0206814 A1
(43) Pub. Date: Aug. 25, 2011

(54) METHOD AND DEVICES FOR MAKING PORTIONS OF FOOD PRODUCTS STUFFED WITH A FILLING

(75) Inventor: Jacques Le Paih, Plumeliau (FR)

(73) Assignee: MAREL STORK FOOD SYSTEMS FRANCE SAS, Baud (FR)

(21) Appl. No.: 13/000,107

(22) PCT Filed: Jun. 23, 2009
(86) PCT No.: PCT/EP2009/057808

§ 371 Date: Mar. 1, 2011

(30) Foreign Application Priority Data
Jun. 24, 2008 (FR) 0854187

(51) Int. Cl. A22C 7/00; A23P 1/08; A23L 1/31; A23L 1/315; A23L 1/317

(52) U.S. Cl. 426/284; 99/353; 99/443 C; 99/450.1

(57) ABSTRACT

The invention relates to a method and a device for making portions of food products stuffed with a filling, formed of a main ingredient containing pieces of animal meat, in particular raw minced meat, surrounding the filling material. The method comprises: making, by extrusion, a main continuous stuffed vein (V1) including an outer layer (C1) of a main material surrounding an inner layer (G1) of a liquid, semi-liquid or pasty filling material; processing the main material before, during and/or after the production of said main vein in order to increase the cohesion of the animal meat pieces constituting said main material; portioning said main vein by nipping the outer layer at least transversally in order to expel the filling material of the inner layer, and by cutting said main vein at the nipped area in order to form portions (P1).

This invention relates to a method for making portions of food products stuffed with a filling, formed of a main material containing pieces of animal meat, in particular raw minced meat, surrounding a filling material, as well as devices for implementing said method.

It is known in particular through patent document EP 1 509 089 a method and device for producing portions of minced meat stuffed with a filling, such as stuffed minced meat steaks. The device includes a mincer provided at the output with two distribution spouts in order to form a lower layer of minced meat and an upper layer of minced meat deposited respectively on a main conveyor and a secondary conveyor. Doses of filling are deposited at regular intervals on the lower layer, and the upper layer is then brought to cover the lower layer and the filling deposited on the latter in order to form a vein of stuffed minced meat, which then passes into a device for cutting and shaping. The device for cutting and shaping comprises means for cutting the vein of minced meat into portions, lateral shaping means acting simultaneously of each side of the vein of minced meat in order to shape the contours of the portions and the vertical shaping means cooperating with said lateral shaping means in order to confer the desired thickness to said portions.

The device requires a perfect synchronisation between the system for depositing doses of filling, the conveyor and the device for portioning in order to carry out the cuts in the middle of the intervals between the doses of filling. Moreover, such a device has a speed in manufacturing portions that is limited.

The purpose of this invention is to propose a solution that aims to overcome the aforementioned disadvantages.

To this effect, this invention has for object a method for making portions of food products stuffed with a filling, formed of a main material containing animal meat in pieces, such as raw minced meat of beef, veal, pork or poultry, or fish flesh, surrounding a filling material, characterised in that said method comprises
a step of producing via extrusion of a main continuous stuffed vein comprising a continuous outer layer of main material surrounding a continuous inner layer of a liquid, semi-liquid or pasty filling material,
a step of processing the main material, before, during and/or after the production of said main vein, for example by cooling and/or gelling, in order to increase the cohesion of the animal meat pieces constituting said main material, in such a way as to obtain an outer layer substantially tight to said filling material,
a step of portioning said main vein by nipping of the outer layer of processed main material, at least transversally, in order to expel the filling material of the inner layer, then by cutting said main vein on its nipped area of the vein substantially devoid of filling material in order to form portions.

According to the invention, the filling material is continuously extruded in the form of a continuous inner layer in a main continuous vein further comprising an outer layer of main material surrounding said inner layer, and the portioning is carried out by nipping the main continuous vein in order to expel the filling. In order to allow for its extrusion and its displacement during the operation of nipping, the filling material is a liquid, semi-liquid or pasty material, for example a sauce with cheese and/or vegetables, such as process cheese or tomato sauce. In order to expel the filling during the operation of nipping of the main vein, substantially without leakage through the outer layer formed of pieces of animal meat, said pieces of animal meat are processed in such a way as to obtain an outer layer sufficiently tight and resistant to expel the material, while maintaining a flexibility that is sufficient to become deformed during the nipping. The main vein is then cut on nipped areas. The method according to the invention allows for the manufacture of stuffed portions, at high speeds, with the portions able to be of diverse shapes and sizes.

In the field of producing food products, fresh products, such as animal meat, are conventionally kept at a temperature between 0° C. and 6° C., typically of about 4° C. Surprisingly, the applicant discovered that a simple cooling of the animal meat to a temperature less than or equal to 0° C., but greater than the freezing point of the animal meat made it possible to obtain a main continuous layer having a flexibility sufficient to be crushed without breaking as well as a cohesion between the pieces sufficient to expel the filling, substantially without leakages. According to an embodiment, said step of processing therefore comprises the cooling of the main material, to a temperature less than or equal to 0° C., and greater than the freezing point of the main material.

The processing temperature is defined according to the freezing temperature of the meat, which depends on the nature of the meat, in particular of its water and salt content. By way of example, for a main ingredient formed of chicken and/or turkey minced meat, with a freezing point of about −4° C., the meat is processed at a temperature of about −3° C. In the case of minced beef meat, such as used in the production of minced meat steaks, the meat is processed at a temperature of about −1° C.

According to an embodiment, the cooling is carried out before the extrusion of said main material in a continuous outer layer. The main material, such as meat in pieces, is minced, then cooled, for example by mixing with nitrogen or carbon dioxide, and/or by passage or storage in a refrigerated enclosure. The cooled minced meat is then extruded. Alternatively, the minced meat is cooled after extrusion.

According to another embodiment, the step of processing is carried out by agglomeration of at least one portion of the pieces of animal meat by means of a gelling agent. The minced meat can be gelled before extrusion, by mixing a gelling agent and a mass of pieces of meat. Advantageously, the meat in pieces, for example minced meat is gelled by adding a composition that can be gelled comprising for example one or several hydrocolloids such as sodium pectate or alginate, pectin, carrageenates, or others, then by gelling said composition. By way of example a solution of sodium alginate is added to the minced meat then a calcium gelling of the alginate is carried out by adding a solution of calcium salt. According to an alternative, the calcium gelling, and possibly the adding of alginate beforehand, are carried out after extrusion of the minced meat, for example by spraying, only a portion on the surface of the outer layer of the vein then being agglomerated.

According to a particularity, said inner layer of filling material constitutes at most 50% of the thickness of the main continuous vein as a transversal section, more preferably at most one-third of the thickness of the main continuous vein.

According to another particularity, said outer layer is carried out by extrusion of animal meat minced into fibrous pieces of lengths less than or equal to 10 mm, more preferably 3 to 4 mm, and/or of transversal section less than or equal to 20 mm².

According to an embodiment, said main continuous vein is obtained by co-extrusion of an annular layer of main material and of the inner layer of filling material. The vein can have a substantially circular outer transversal section. The portioning is then carried out more preferably by means of nippers acting substantially symmetrically on either side of the main vein. The main vein can also have a substantially rectangular transversal section.

According to another embodiment, said main continuous vein is obtained by
extrusion of a continuous lower secondary layer of main material,
extrusion of a continuous inner layer of filling material and depositing said inner layer on the lower secondary layer, and
extrusion of a continuous upper secondary layer of main material and depositing said upper secondary layer for covering said lower secondary layer and the continuous inner layer deposited on the latter,

said upper secondary layer resting on either side of the inner layer on the lower secondary layer, and forming with the latter the outer layer of the main continuous vein.

This invention further also has for object a device for producing portions of filled food products for the implementation of the method described previously, characterised in that it comprises:
an extrusion system able to extrude two different materials in order to form a main continuous stuffed vein comprising a continuous outer layer of a main material surrounding a continuous inner layer of a filling material,

and a system for portioning comprising
a conveyor belt able to receive on its upper strand said main continuous vein,
at least one nipping bar arranged over said conveyor belt able to be displaced in the direction of the conveyor belt by first means of displacing for nipping said main continuous vein at least substantially transversally between its lower edge and the upper strand of the conveyor belt
at least one cutting blade, arranged over said conveyor belt, downstream of said nipping bar in relation to the forward direction of the main continuous vein, able to be displaced in the direction of the conveyor belt by second means of displacing for cutting into portions said main continuous vein on nipped areas.

According to another embodiment, the device is characterised in that it comprises

a co-extrusion head for forming a main continuous vein comprising a continuous outer layer of a main material surrounding a continuous inner layer of a filling material, said co-extrusion head comprising

a first duct defining a main passage intended to be supplied with a main material, and presenting a substantially circular output orifice, and

a second duct arranged at least partially concentrically inside main passage defining a secondary passage intended to be supplied with a filling material and having an output orifice, more preferably substantially circular, the diameter of the output orifice of the second duct being substantially less than or equal to half of the diameter of the output orifice of the first duct, and

a system for portioning comprising

means for nipping comprising at least one pair of opposite nippers able to be displaced towards one another by first means of actuating from an open position to a closed position for nipping the main vein, said first means of actuating being able to move closer and move away according to a back-and-forth movement in the orthogonal direction as well as in the direction parallel to the transport direction of the main vein, the speed of displacement of the nippers being substantially equal to the speed of transport of the bead when the nippers are in contact with the bead for the operations of nipping and cutting, and variable outside of the operations of nipping and cutting,

each nippers of said pair comprising at least two main plates provided at the end with a front nipping edge and arranged in such a way that, during the displacement of the nippers towards their closed position, the main plates of the nippers are positioned in alternation, with two adjacent plates not belonging to the same nippers, and form by their front nipping edge passages or diaphragms of which the section decreases progressively,
means for cutting comprising at least one blade associated to the pair of nippers able to be displaced, by second means of actuating between the passages in order to cut the main vein.

The invention shall be better understood, and other purposes, details, characteristics and advantages shall appear more clearly in the detailed explanatory description which shall follow of two currently preferred particular embodiments of the invention, in reference to the annexed diagrammatical drawings, wherein:

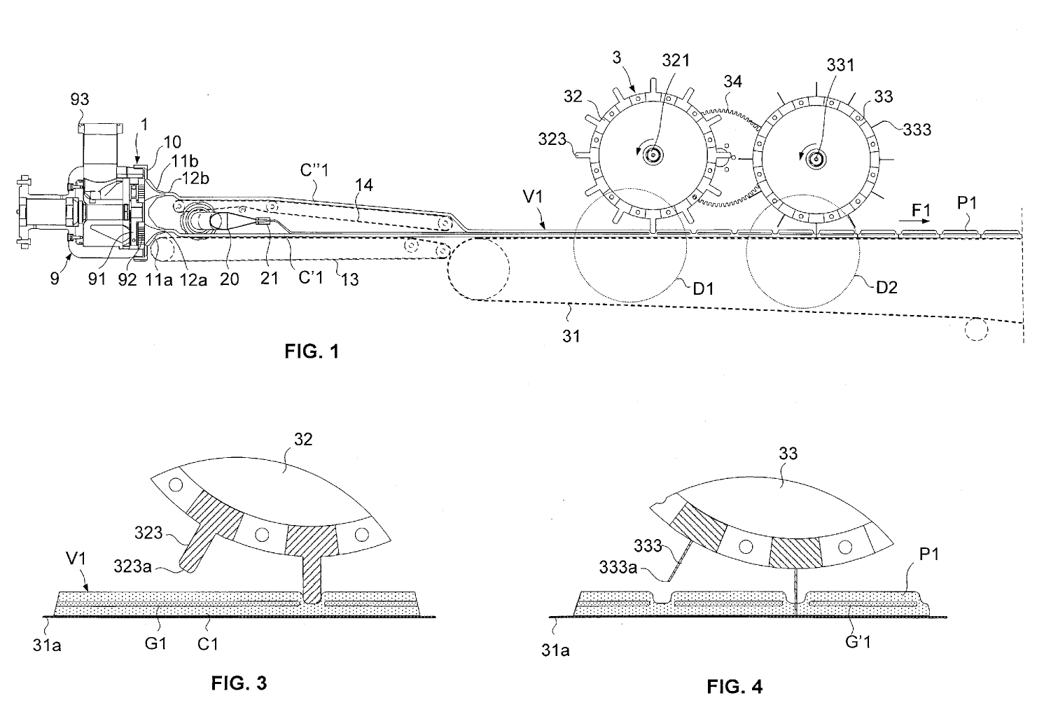

FIG. 1 shows a partial diagrammatical longitudinal cross-section view of a device for producing portions of food products stuffed with a filling according to a first embodiment;

FIG. 2 shows a partial perspective view of the device in FIG. 1;

FIG. 3 shows an enlarged view of the detail D1 of FIG. 1, showing the nipping of the main continuous stuffed vein;

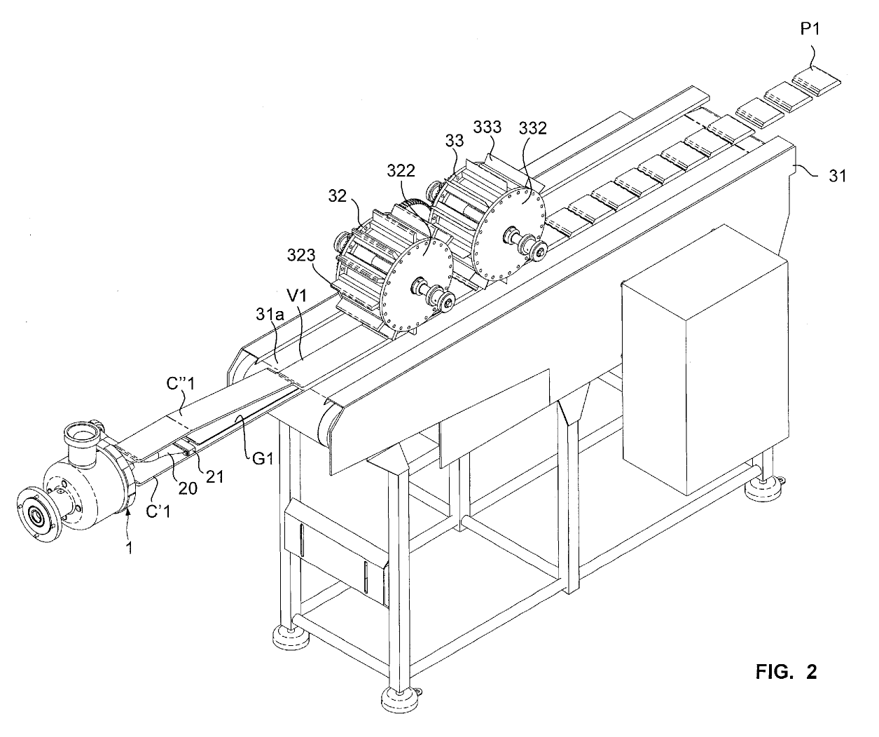

FIG. 4 shows an enlarged view of the detail D2 of FIG. 3, showing the cut of the main vein;

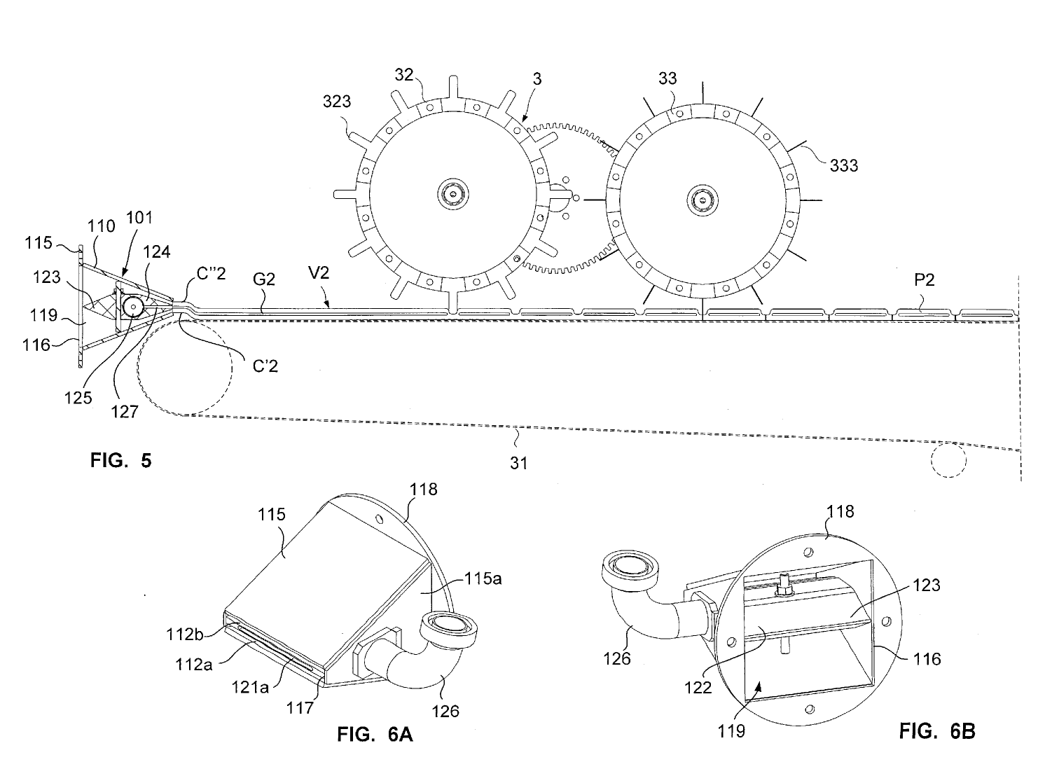

FIG. 5 is a partial diagrammatical longitudinal cross-section view of an alternative embodiment of the device in FIG. 1;

FIGS. 6A and 6B show two enlarged perspective views of the co-extrusion head of the device in FIG. 5;

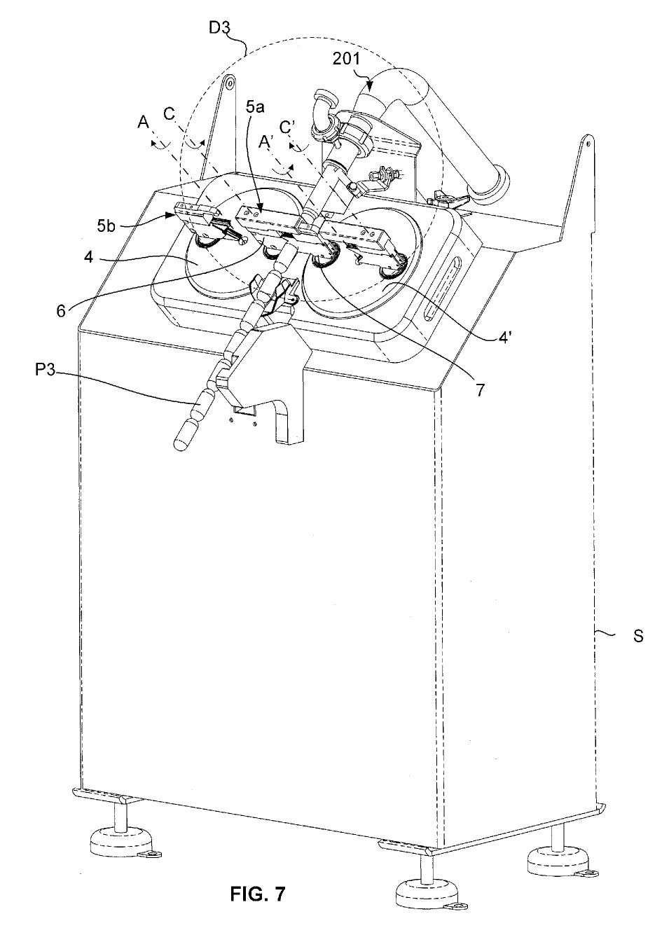

FIG. 7 is a partial perspective view of a device for producing portions of food products stuffed with a filling according to a second embodiment;

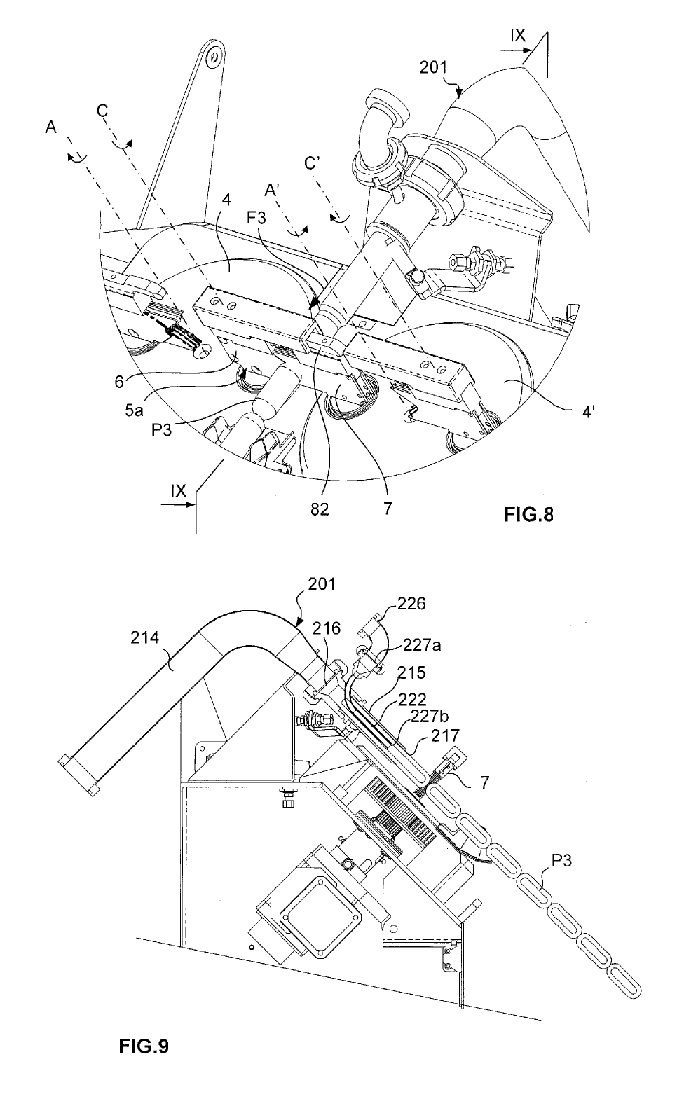

FIG. 8 is an enlarged view of the detail D3 in FIG. 7;

FIG. 9 is a view according to the vertical section plane IX-IX in FIG. 7;

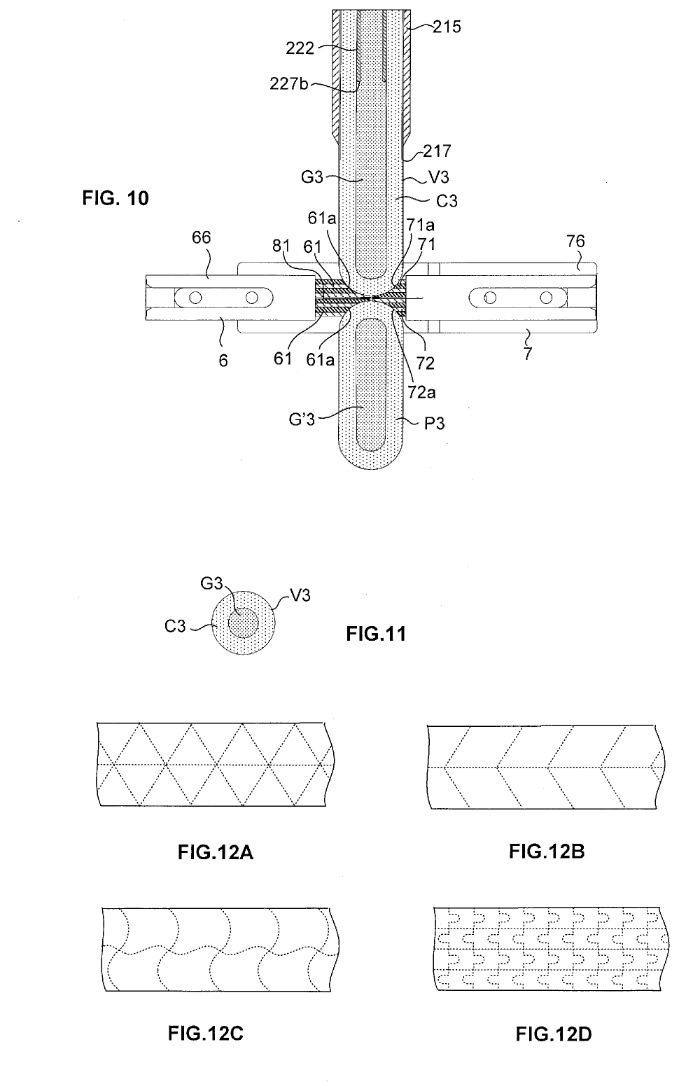

FIG. 10 is a cross-section view according to a section plane perpendicular to the axes of rotation of the nippers, substantially according to the longitudinal axis of the main vein;

FIG. 11 is a transversal cross-section view of the main vein obtained by the device in FIG. 7; and,

FIGS. 12A to 12D show partial views of the top of the main veins that can be obtained by the device of FIG. 1 or 5, wherein are diagrammatically shown alternative embodiments for the operations of nipping and cutting.

Considering first FIGS. 1 to 3, these diagrammatically show a device for the production of portions of food products according to a first embodiment intended in particular for the production of patties P1 of raw minced meat, of a generally parallelepiped shape, provided with an interior filling G′1.

The device comprises an extrusion system 1 making it possible to continuously extrude a main continuous vein V1 formed of a continuous outer layer C1 of minced meat surrounding an inner layer G1 of a filling material, such as a paste of process cheese, and a device for portioning 3.

Said extrusion system comprises a first extrusion head 10 comprising two extrusion spouts 11a, 11b, offset vertically from each other, each comprising an extrusion orifice 12a, 12b of substantially rectangular section in order to form a lower secondary layer C′1 and an upper secondary layer C″1 of minced meat. This first extrusion head is mounted at the output of a device for regulating flow (not shown), of the stuffer type, such as a piston pump or a vane pump, supplied via a hopper with a material referred to as the main material, constituted of minced meat. Such as shown in FIG. 1, the co-extrusion head is associated to a mincer 9 conventionally comprising a rotary knife 91 and an output grid 92. The head is mounted at the output of the mincer, behind the output grid, with the entrance 93 of the mincer being connected to the discharge outlet of the pump. The two secondary layers C′1 and C″1 existing from the orifices 12a and 12b have for example a threaded structure of the “angel's hair” type created by the output grid of the mincer.

In reference to FIG. 1, the lower layer C′1 is deposited on the upper strand of a lower secondary conveyor belt 13, while the upper layer is received on the upper strand of an upper secondary conveyor belt 14, arranged above the lower secondary conveyor belt 13. The two conveyor belts, not shown in FIG. 2 for the purposes of simplification and clarity, are driven substantially in iso-speed.

The extrusion head system comprises a second extrusion head 20 arranged downstream of the first extrusion head, between the two secondary conveyor belts, for the extrusion on the lower layer C′1 of a continuous inner layer G1 of filling material, of width less than that of the lower layer, and substantially in the centre of the latter. This second extrusion head is also connected to a device for regulating flow (not shown), and has a distribution spout 21 provided with a substantially rectangular distribution orifice having a width less than that of the distribution orifices pour the secondary layers of minced meat.

The lower layer C′1 covered with the layer of filling G1 is taken on the upper strand 31a of a conveyor belt, referred to as the main conveyor belt 31, of the portioning system.

The downstream return wheels of the secondary conveyor belts are positioned substantially to the vertical of each other, in such a way that the upper layer C″1 is deposited at the output of the upper secondary conveyor belt on the lower layer C′1 and the inner layer of filling coming to be deposited, in order to form the main continuous vein V1. On either side of the inner layer of filling, the upper secondary layer C″1 rests on the lower secondary layer C′1 and forms with the latter the outer layer C1 of the main continuous vein. Alternatively the lower secondary conveyor belt 13 is confounded with the main conveyor belt 31.

The thicknesses of the secondary layers are substantially identical. In this embodiment, the thickness of each of the lower and upper secondary layers C′1, C″1 is more than two times greater than that of the layer of filling G1.

The portioning system, shown partially and diagrammatically in the figures, comprises said main conveyor belt 31 and, arranged successively above said conveyor belt, from upstream to downstream in relation to the forward direction F1 of the main vein, a nipping wheel 32, of the vaned-wheel type, then a cutting wheel 33.

In reference to the FIGS. 2 and 3, the nipping wheel 32 has an axis 321, arranged transversally to the forward direction F1, and carrying two plates 322. Between these plates, is mounted a plurality of straight transversal nipping bars 323 arranged with regular angular spacing, parallel to the axis 321, and extending radially towards the exterior. The nipping wheel 32 is arranged above the main conveyor belt, in such a way that each bar is able to come nip the main vein between its transversal outer edge 323a and the upper strand 31a of the main conveyor belt. As can be seen better in FIG. 3, when a bar is positioned substantially vertically, its outer edge 323a, more preferably rounded, is arranged at a distance from the upper strand 31a in such a way as to crush across its entire width the main vein, on an area referred to as nipped or crushed, without sectioning it. By way of example, the distance between the outer edge 323a and the upper strand 31a corresponds to approximately half of the total thickness of the main vein.

During this operation of nipping, the filling of the inner layer G1 is expelled substantially perpendicularly to the transversal bar, in such a way that the nipped area is substantially devoid of filling. For this, according to the invention, the minced meat constituting the outer layer of the main vein was cooled beforehand to a processing temperature less than 0° C., but greater than the freezing temperature of the minced meat. According to an embodiment, before extrusion, the minced meat is mixed with nitrogen in order to be cooled down to a processing temperature, for example of about −3° C. for turkey or chicken minced meat. The cooled minced meat is loaded into the hopper of the pump and is then extruded into two secondary layers, such as described previously, in order to form a main vein with a cooled outer layer which is transferred as it is formed towards the nipping wheel and the cutting wheel. Alternatively, as a replacement for the aforementioned heat treatment, the minced meat is gelled before extrusion by mixing with a solution of sodium alginate, then by mixing with a solution of calcium acetate in order to gel the alginate. The minced meat is then extruded at a conventional temperature of about of 4° C.

The cutting wheel 33 has an axis 331, arranged transversally in the forward direction F1, carrying two plates 332. Between these plates, is mounted a plurality of transversal flat blades 333, arranged with regular angular spacing, parallel to the axis, and extending radially towards the exterior. The wheel is arranged above the main conveyor belt in such a way that each flat blade is able to come cut the main vein V1 across its entire thickness, substantially in the middle of a nipped area, via its transversal cutting edge 333a. As can be seen better in FIG. 4, when a flat blade is positioned substantially vertically, its cutting edge 333a, is arranged against the upper strand 31a of the main conveyor belt in such a way as to section the main vein and form stuffed portions P1.

The nipping wheel and the cutting wheel are driven in iso-speed by a common drive system 34, and in synchronism with the main conveyor belt.

According to alternative embodiments, the nipping wheel and the cutting wheel are adapted to crush and section longitudinally the vein in order to form at least two portions in the width of the main vein and/or to form identical portions with curved or triangular contours for example, without loss of material. FIGS. 12A to 12D show diagrammatical top views of main veins wherein are shown in dashed lines the lines of nipping and of cutting that can be carried out by mounting on the nipping and cutting wheels nipping bars and complementary cutting blades of appropriate shapes, in order to form portions of different shapes.

In an alternative embodiment shown in FIG. 5, the extrusion system 101 comprises a single co-extrusion head 110 in order to simultaneously extrude an inner layer of filling G2 between an upper secondary layer C″2 and a lower secondary layer C′2 of minced meat.

In reference to FIGS. 5, 6A and 6B, the co-extrusion head comprises a tubular duct 115 comprising an internal passage 119 of rectangular section decreasing progressively from its first opening 116 to its second opening 117. The duct is provided at its first opening with a clamp 118 for its assembly at the output of a pump or of a mincer associated to a pump. A part 122 is mounted inside the internal passage in order to subdivide it into two identical secondary passages and form at the second opening two distribution orifice 112a, 112b for the extrusion of the lower and upper secondary layers C′2, C″2. The part 122 has an upstream portion 123 in the shape of a corner, of longitudinal isosceles triangle section, in order to provide the division of the flow of minced meat entering into the co-extrusion head, and a downstream portion 124 also in the shape of a corner in order to form the two distribution orifice. Said part extends over the entire width of the internal passage of the duct, from one lateral wall to the other of the duct. Said part 122 is provided with a cylindrical transversal channel 125 which exits onto one 115a of the lateral walls and which is intended to be connected, via a duct 126, to a device of the stuffer type in order to be supplied with a filling material. This transversal channel is extended by a longitudinal channel 127 exiting on the end of the downstream portion 124 of the part in order to form an orifice of distribution 121a for the extrusion of the filling, of width less than those of the distribution orifices of minced meat.

The co-extrusion head 110 is for example arranged directly over the upper strand 31a of the main conveyor belt 31 of a device for portioning such as described previously in order to form portions P2. At the output of the co-extrusion head, the upper secondary layer C″2 rests on the lower secondary layer C′2 on either side of the inner layer of filling in order to form the outer layer C2 of a main vein V2.

Alternatively, the aforementioned co-extrusion head can be adapted to directly extrude a main vein generally of rectangular section, comprising an annular outer layer of minced meat surrounding a central layer of filling, the head then comprising a single annular distribution orifice in order to extrude the minced meat.

FIG. 7 diagrammatically shows a device for making portions of food products according to a second embodiment, in particular for the production of substantially cylindrical stuffed portions P3 formed of an annular outer layer C3 of raw minced meat, surrounding a substantially cylindrical layer of a filling material G′3.

The device comprises a co-extrusion head 201 making it possible to continuously extrude a main vein V3 formed of an annular outer layer C3 of minced meat surrounding an inner layer G3 of filling material, such as shown in particular in FIG. 11.

In reference to FIGS. 8 and 9, the co-extrusion head 201 comprises a first duct 215 defining a main passage, of substantially circular transversal section, with an input orifice 216 and an output orifice 217 intended to be connected via a connection duct 214 to the output of a conventional device of the “stuffer” type, in order to be supplied with cooled minced meat at a processing temperature, such as described previously.

The co-extrusion head comprises a second duct 222 defining a secondary passage, for example of substantially circular transversal section, with an input orifice 227a and an output orifice 227b. This second duct, intended to be supplied with filling material, comprises a straight portion which is arranged coaxially in the main passage, and of which the free end, arranged withdrawn in relation to the output orifice 217 of the first duct, defines the output end 227b of the secondary passage. This first portion is extended by an elbow-shaped portion extending through the wall of the first duct and delimited by the input orifice 227a. The input orifice is provided with a connector 226 for the connection of the secondary passage to a conventional device of the “stuffer” type in order to supply said passage with filling material.

In this embodiment the diameter of the output orifice of the secondary passage for the extrusion of the filling is substantially equal to half of the diameter of the output orifice of the main passage.

The device comprises a system for portioning comprising a pair of opposite nippers able to be displaced towards one another by means of actuating from an open position to a closed position in order to nip the main vein exiting from the co-extrusion head. The two nippers are arranged and displaced in such a way that a passage subsists in the closed position. The portioning system further comprises means for cutting comprising a blade associated to the pair of nippers, able to be actuated by means of actuating in order to cut the main vein on the nipped area when the nippers are in closed position.

The device for portioning is for example of the type described in French patent application 07 03162. The nippers of each pair are mounted rotatingly on rotating discs in order to be displaced according to a back-and-forth movement by circular translation. In reference in particular to FIGS. 7 and 8, the device comprises a support frame S on the upper portion whereon are mounted a first rotating disc 4, with axis of rotation A, and a second rotating disc 4′ with axis of rotation A′, the two axes of rotation being arranged in parallel to one another and substantially perpendicularly to the forward direction F3 of the main vein to be portioned. A first pair 5a of nippers comprises a first nippers 6 mounted pivoting on the first rotating disc 4 around an axis of rotation C arranged in parallel to the axis of rotation A of the disc and at a distance from the latter, and a second nippers 7 mounted analogously on the second disc 4′ around an axis of rotation C′ parallel to the axis A′.

In reference to FIGS. 8 and 11, the first nippers 6 comprise four main plates 61 parallel with one another, and spaced from one another. Each plate has at its front end a notch which defines a front nipping edge 61a in the general shape of a V. The main plates are integral with a mounting part 66 by which the nippers are mounted pivoting on the first disc, with its plates being arranged in parallel to the axis of rotation C. Similarly, the second nippers 7 comprise four main plates 71 with nipping edges 71a, and a mounting part 76.

The discs are driven in rotation around their axis A and A′ in inverse directions, in such a way that the nippers are displaced in the forward direction F3 of the vein when they are in contact with the latter, and at the same speed as that of the main vein, and the nippers are driven in rotation on the discs around their axis C and C′ in such a way as to remain arranged constantly perpendicular to the transport direction F3 of the vein, and parallel to one another, with their front edge opposite.

During the displacement of the nippers towards the closed position shown in FIGS. 7 and 8, the main plates of a nippers are inserted with those of the other nippers in such a way that two successive plates 41, 71 overlap in the manner of shears and form with their front edges 41a, 71a a passage or diaphragm of which the section decreases progressively, in order to progressively nip the main vein.

As can be seen in FIG. 11, the nipping edges of the main plates have different profiles, in such a way that in the closed position, the openings of the diaphragms formed by the main outer plates of the nippers are greater than those of the diaphragms formed by the main central plates. During the progressive nipping, the filling is progressively expelled from the nipping area. Advantageously, each nippers further comprises four secondary plates 62, 72 arranged in alternation with the main plates of the nippers, each secondary plate of a nippers comprising a front edge, of complementary form with the front edge of the main plate of the other nippers arranged opposite in a closed position of the nippers, said front edge comprising a central portion of nipping 62a, 72a.

The cutting system comprises a flat blade 81, diagrammatically shown in FIG. 10, mounted pivotingly on the first nippers, between the two main central plates. The blade is solicited elastically by a spring in a retracted position wherein the blade is arranged between the two plates, withdrawn in relation to their nipping edge 61a. The blade is able to cooperate with the free end of an actuating finger 82 (FIG. 8) mounted on the second nippers 7 in the closed position of the nippers in order to pivot the blade against the spring towards an active position in order to cut the nipped area of the main vein.

Such as shown in the figures, the rotating discs can include a second pair of nippers. On each disc, the nippers are arranged symmetrically on either side of the axis of rotation of the disc.

Although the invention has been described in liaison with various particular embodiments, it is of course obvious that is in no way limited to this and that it comprises all of the equivalent techniques of the means described as well as their combinations if the latter enter within the scope of the invention.

1. Method for making portions of food products stuffed with a filling, formed of a main material containing animal meat in pieces, such as raw minced meat of beef, veal, pork or poultry, or fish flesh, surrounding a filling material, characterised in that said method comprises
a step of producing via extrusion of a main continuous stuffed vein (V1, V2, V3) comprising an outer layer (C1, C2, C3) of main material surrounding an inner layer (G1, G2, G3) of a liquid, semi-liquid or pasty filling material,
a step of processing the main material, before, during and/or after the production of said main continuous vein, in order to increase the cohesion of the pieces of animal meat constituting said main material,
a step of portioning said main continuous vein by nipping the outer layer of processed main material, at least transversally, in order to expel the filling material of the inner layer, then by cutting said main vein on its nipped area substantially devoid of filling material in order to form portions (P1, P2, P3).

2. Method according to claim 1, characterised in that said step of processing comprises the cooling of the main material, to a temperature less than or equal to 0° C., and greater than the freezing point of the main material.

3. Method according to claim 2, characterised in that the cooling is carried out before the extrusion of said main material in continuous outer layer (C1, C2, C3).

4. Method according to claim 1, characterised in that the step of processing is carried out by agglomeration of at least one portion of the pieces of animal meat by means of a gelling agent.

5. Method according to claim 1, characterised in that said inner layer (G1, G2, G3) of filling material constitutes at most 50% of the thickness of the main continuous vein (V1, V3, V3) as a transversal section, more preferably at most one-third of the thickness of the main continuous vein.

6. Method according to claim 1, characterised in that said outer layer (C1, C2, C3) is carried out by extrusion of animal meat minced into fibrous pieces of lengths less than or equal to 10 mm, and of transversal section less than or equal to 20 mm².

7. Method according to claim 1, characterised in that said main continuous vein (V3) is obtained by co-extrusion of an outer annular layer (C3) of main material and of the inner layer (G3) of filling material.

8. Method according to claim 1, characterised in that said main continuous vein (V2) is obtained by
extrusion of a continuous lower secondary layer (C′1) of main material,
extrusion of an inner layer (G1) of filling material and depositing said inner layer on the lower secondary layer, and
extrusion of an upper secondary layer (C″1) of main material and depositing said upper secondary layer for covering said lower secondary layer and the continuous inner layer deposited on the latter,
said upper secondary layer resting on either side of the inner layer on the lower secondary layer, and forming with the latter the continuous outer layer (C1) of the main continuous vein.

9. Device for the production of portions of stuffed food products for the implementation of the method according to claim 1, characterised in that it comprises
an extrusion system (1, 101) able to extrude two different materials in order to form a main continuous stuffed vein (V1, V2) comprising an outer layer (C1, C2) of a main material surrounding an inner layer (G1, G2) of a filling material,
and a system for portioning comprising
a conveyor belt (31) able to receive on its upper strand (31a) said main continuous vein,
at least one nipping bar (323) arranged over said conveyor belt able to be displaced in the direction of the conveyor belt by first means of displacing for nipping said main continuous vein at least substantially transversally between its lower edge and the upper strand (31a) of the conveyor belt,
at least one cutting blade (333), arranged over said conveyor belt, downstream of said nipping bar in relation to the forward direction (F1) of the main continuous vein, able to be displaced in the direction of the conveyor belt by second means of displacing for cutting into portions said main continuous vein on nipped areas of said main continuous vein.

10. Device for the production of portions of stuffed food products for the implementation of the method according to claim 1, characterised in that it comprises
a co-extrusion head (201) for forming a main continuous vein (V3) comprising an outer layer (C3) of a main material surrounding an inner layer (G3) of a filling material, said co-extrusion head comprising
a first duct (215) defining a main passage intended to be supplied with a main material, and having a substantially circular output orifice (217), and
a second duct (222) arranged at least partially concentrically inside the main passage, defining a secondary passage intended to be supplied with a filling material and having a substantially circular output orifice (227b), the diameter of the output orifice of the second duct being substantially less than or equal to half of the diameter of the output orifice of the first duct, and
a system for portioning comprising
means for nipping comprising at least one pair of opposite nippers (6, 7) able to be displaced towards one another by the first means of actuating from an open position to a closed position in order to nip the main vein, said first means of actuating being able to move closer and move away according to a back-and-forth movement in the orthogonal direction as well as in the direction parallel to the transport direction (F3) of the main vein (V3), each nippers of said pair comprising at least two main plates (61, 71) provided at the end with a front nipping edge (61a, 71a) and arranged in such a way that, during the displacement of the nippers towards their closed position, the main plates of the nippers are positioned in alternation, and form by their front nipping edge passages or diaphragms of which the section decreases progressively,
means for cutting comprising at least one cutting blade (82) associated to the pair of nippers able to be displaced, by second means of actuating, between the passages in order to cut the main vein.
